(19) United States
(12) Patent Application Publication
(10) Pub. No.: US 2026/0222493 A1
(43) Pub. Date: Jul. 30, 2026

(54) METHODS, SYSTEMS, AND COMPUTER READABLE MEDIA FOR PROVIDING ALERTING MECHANISM FOR DEEPFAKE VOICE DETECTION BY PROXY CALL SESSION CONTROL FUNCTION (P-CSCF)

(71) Applicant: Orade International Corporation, Redwood Shores, CA (US)

(72) Inventors: Akash A, Bangalore (IN); Arvind Kumar Singh, Bangalore (IN); Agnivesh Kumpati, Hyderabad (IN)

(21) Appl. No.: 19/039,194

(22) Filed: Jan. 28, 2025

(51) Int. Cl. H04M 7/00; G10L 25/69

(52) U.S. Cl. CPC H04M 7/0078; G10L 25/69

(57) ABSTRACT

A method for providing an alerting mechanism for deepfake voice detection by a proxy call session control function (P-CSCF) includes receiving, by a P-CSCF, media packets transmitted from a first communication endpoint to a second communication endpoint. The method further includes using, by the P-CSCF, an artificially generated voice detection algorithm to detect that the media packets carry artificially generated voice content. The method further includes generating, by the P-CSCF, an alert indicating an occurrence of an artificially generated voice detection event. The method further includes communicating, by the P-CSCF, the alert to the second communication endpoint.

### TECHNICAL FIELD

The subject matter described herein relates to providing alerts related to artificial intelligence (AI)-generated and other artificially generated voice communicated to users via communication endpoints. More particularly, the subject matter described herein relates to providing an alerting mechanism for deepfake voice detection by a P-CSCF.

### BACKGROUND

A deepfake voice is a synthetic voice that mimics real human voice. Deepfake voice or audio can be artificially generated using a generative artificial intelligence (AI) model. The rapid proliferation of generative AI technologies, particularly in speech synthesis and deepfake voice generation, poses significant challenges to authenticity and trust in audio communications. As generative AI services become more accessible and sophisticated, distinguishing between human-generated and AI-generated voices is increasingly difficult. This blurring of lines raises critical concerns across various sectors where the misuse of synthetic voices can lead to misinformation, fraud, and identity theft. While the pressing need for robust mechanisms to detect AI-generated audio is paramount, conveying this detected information to users in a clear and actionable manner is also crucial.

Even though algorithms exist for detecting AI-generated voice, there is no standard and efficient mechanism for alerting end users that the voice they are hearing during a telecommunications media session is artificially generated. Accordingly, in light of these and other difficulties, there exists a need for improved methods, systems, and computer readable media for providing an alerting mechanism for deepfake voice detection.

### SUMMARY

A method for providing an alerting mechanism for deepfake voice detection by a proxy call session control function (P-CSCF) includes receiving, by a P-CSCF, media packets transmitted from a first communication endpoint to a second communication endpoint. The method further includes using, by the P-CSCF, an artificially generated voice detection algorithm to detect that the media packets carry artificially generated voice content. The method further includes generating, by the P-CSCF, an alert indicating an occurrence of an artificially generated voice detection event. The method further includes communicating, by the P-CSCF, the alert to the second communication endpoint.

According to another aspect of the subject matter described herein, receiving the media packets includes receiving real-time transport protocol (RTP) media packets transmitted from the first communication endpoint.

According to another aspect of the subject matter described herein, using the artificially generated voice detection algorithm includes using an artificially generated voice detection algorithm that examines media packet size and timing distributions to detect that the media packets carry artificially generated voice content.

According to another aspect of the subject matter described herein, using the artificially generated voice detection algorithm includes using an algorithm that performs audio codec fingerprinting to detect that the media packets carry artificially generated voice content.

According to another aspect of the subject matter described herein, generating the alert includes generating an audio tone or an announcement indicating the occurrence of the artificially generated voice detection event.

According to another aspect of the subject matter described herein, transmitting the alert to the second communication endpoint includes transmitting the alert in-band to the second communication endpoint.

According to another aspect of the subject matter described herein, transmitting the alert in-band includes multiplexing the alert with the media packets generated by the first communication endpoint.

According to another aspect of the subject matter described herein, multiplexing the alert with the media packets generated by the first communication endpoint includes generating at least one real-time transport protocol (RTP) packet, adding the alert as a payload to the at least one RTP packet, and adding the at least one RTP packet to a stream of the media packets generated by the first communication endpoint.

According to another aspect of the subject matter described herein, communicating the alert to the second endpoint includes communicating the alert out-of-band to the second communication endpoint.

According to another aspect of the subject matter described herein, the method for providing an alerting mechanism for deepfake voice detection includes receiving, by the P-CSCF and from the second communication endpoint, a SUBSCRIBE message for subscribing to an artificially-generated voice detection event and communicating the alert out-of-band to the second communication endpoint includes generating a NOTIFY message, adding the alert to the NOTIFY message, and transmitting the NOTIFY message including the alert to the second communication endpoint.

According to another aspect of the subject matter described herein, a system for providing an alerting mechanism for deepfake voice detection by a P-CSCF is provided. The system includes a P-CSCF including at least one processor and a memory, the P-CSCF for receiving media packets transmitted from a first communication endpoint to a second communication endpoint and using an artificially generated voice detection algorithm to detect that the media packets carry artificially generated voice content. The system further includes an artificially generated voice content detection event alert generator/communicator implemented by the at least one processor for generating an alert indicating an occurrence of an artificially generated voice detection event and communicating the alert to the second communication endpoint.

According to another aspect of the subject matter described herein, the artificially generated voice detection algorithm examines media packet size and timing distributions to detect that the media packets carry artificially generated voice content.

According to another aspect of the subject matter described herein, the artificially generated voice detection algorithm performs audio codec fingerprinting to detect that the media packets carry artificially generated voice content.

According to another aspect of the subject matter described herein, the artificially generated voice content detection alert generator/communicator is configured to generate an audio tone or an announcement indicating the occurrence of the artificially generated voice detection event.

According to another aspect of the subject matter described herein, the artificially generated voice content detection alert generator/communicator is configured to transmit the alert to the second communication endpoint in-band.

According to another aspect of the subject matter described herein, the system for providing an alerting mechanism for deepfake voice detection includes an audio multiplexer configured to multiplex the alert with the media packets generated by the first communication endpoint.

According to another aspect of the subject matter described herein, the audio multiplexer is configured to multiplex the alert with the media packets generated by the first communication endpoint by generating at least one RTP packet, adding the alert as a payload to the at least one RTP packet, and adding the at least one RTP packet to a stream of the media packets generated by the first communication endpoint.

According to another aspect of the subject matter described herein, the artificially generated voice content detection event alert generator/communicator is configured to communicate the alert out-of-band to the second communication endpoint.

According to another aspect of the subject matter described herein, the artificially generated voice content detection event alert generator/communicator is configured to receive, from the second communication endpoint, a SUBSCRIBE message for subscribing to an artificially-generated voice detection event and to communicate the alert to the second communication endpoint out-of-band by generating a NOTIFY message, adding the alert to the NOTIFY message, and transmitting the NOTIFY message including the alert to the second communication endpoint.

According to another aspect of the subject matter described herein, a non-transitory computer readable medium having stored thereon executable instructions that when executed by a processor of a computer control the computer to perform steps is provided. The steps include receiving, by P-CSCF, media packets transmitted from a first communication endpoint to a second communication endpoint. The steps further include using, by the P-CSCF, an artificially generated voice detection algorithm to detect that the media packets carry artificially generated voice content. The steps further include generating, by the P-CSCF, an alert indicating an occurrence of an artificially generated voice detection event. The steps further include communicating, by the P-CSCF, the alert to the second communication endpoint.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer-readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating a proposed architecture for alerting users of deepfake voice detection;

FIG. 2 is a message flow diagram illustrating exemplary messages exchanged for an in-band mechanism for alerting an end user of deepfake voice detection;

FIG. 3 is a message flow diagram illustrating exemplary messages exchanged for an out-of-band mechanism for alerting an end user of deepfake voice detection;

FIG. 4 is a block diagram illustrating an exemplary architecture for a P-CSCF that generates and sends alerts to communication endpoints when deepfake voice is detected; and

FIG. 5 is a flow chart illustrating an exemplary process for providing an alerting mechanism for deepfake voice detection.

### DETAILED DESCRIPTION

The subject matter described herein provides an alerting mechanism for deepfake voice detection using an Internet protocol (IP) multimedia subsystem (IMS) node for alerting, in real time, communication endpoints of the presence of AI-generated or other artificially generated voice in a media session between the communication endpoints.

In one example, the alerting mechanism involves a two-step process. The first step is detection of the artificially-generated voice. Artificially-generated voice can be detected using an existing method or a new method. The subject matter described herein is not intended to be limited to any particular method for detecting artificially-generated voice. The following methods may be used but are not intended to limit the scope of the subject matter described herein.

One detection method that can be used is real-time transport protocol (RTP) packet analysis. RTP is defined in Internet Engineering Task Force (IETF) request for comments (RFC) 3550 and is used to carry real-time data, such as audio and video data, over networks. In IMS networks, RTP is used to carry media (where media includes voice and/or video data) packets between communication endpoints. When a user speaks into a communication endpoint, such as a mobile phone or a landline phone, the voice signal is digitized using an analog-to-digital converter, compressed using a coder/decoder (codec) algorithm, and, in the case of RTP, packetized for transmission over the network to other communication endpoints. For the case of artificially-generated voice, because the voice signal is generated using an algorithm rather than a real user, the RTP packets may have different size distributions and/or timing distributions than RTP packets that carry human-generated voice. For example, there may be detectable patterns in the timing and size distributions of RTP packets for artificially generated voice that are not present in RTP packets that carry human generated voice. Accordingly, one method for detecting the presence of artificially-generated voice may include analyzing characteristics, such as timing and size distributions of RTP packets. Other characteristics of RTP packets that may be analyzed to detect the presence of artificially-generated voice includes packet interarrival times, packet header parameters, jitter, packet loss, and burstiness. Again, RTP packets carrying artificially-generated voice may have detectable patterns of packet interarrival times, packet header parameters, jitter, packet loss, and burstiness that are not present in RTP packets that carry human-generated voice. Along with or instead of these mechanisms, machine learning techniques can also be used to detect the presence of artificially-generated voice.

Another method for detecting the presence of artificially-generated voice is audio codec fingerprinting. As described above, an audio codec is used to compress and encode digitized voice samples for transmission over a network. Audio codec fingerprinting is the process of analyzing the encoded signals for patterns or characteristics that are indicative of a particular source or type of audio signal. Audio codec fingerprinting techniques suitable for use in detecting artificially-generated voice include spectral analysis, bitstream analysis, pattern recognition, and machine learning techniques that utilize unique characteristics, i.e., fingerprints, produced by different audio compression algorithms to identify the origin and authenticity of audio streams. In general, the synthesized audio often undergoes a different compression history compared to recordings of human generated voice and the differences in compression algorithms can be used to detect the presence of artificially generated voice.

The second step in the deep fake voice detection alerting mechanisms described herein is alerting the user of the presence of artificially-generated voice. Two methods for alerting end users via their communication endpoints of the presence of artificially generated voice include in-band methods and out-of-band methods, where “band” refers to the existing media channel between the end user being alerted and the machine, sometimes referred to as a bot, that generates the artificially-generated voice. For in-band methods, once the artificially-generated voice detection algorithm detects the presence of artificially-generated voice, in one example, a pre-recorded announcement, such as, “The voice you're hearing is probably generated using an AI system” is multiplexed with the original media stream using an audio multiplexer. Alternatively, a unique alert tone can also be periodically multiplexed into the original media stream and alert the user in real time. The audio multiplexer processes both the alert stream and the original artificially-generated voice stream and produces a combined output stream.

Such multiplexing can occur in an IMS node in the media path between the real user and the bot generating the fake voice signal. In one example, the IMS node may be a P-CSCF. A P-CSCF is an IMS node that performs out-of-band signaling, media stream forwarding, optional transcoding, and other functions for IMS communication sessions. The signaling performed by the P-CSCF includes signaling to set up and tear down media sessions. Such signaling may be performed using the session initiation protocol (SIP) as defined in IETF RFC 3261. SIP messages carry session description protocol (SDP) content for describing the underlying media sessions. The SDP is defined in IETF RFC 4566 and is used to describe the type and format of the media data being exchanged in the media session.

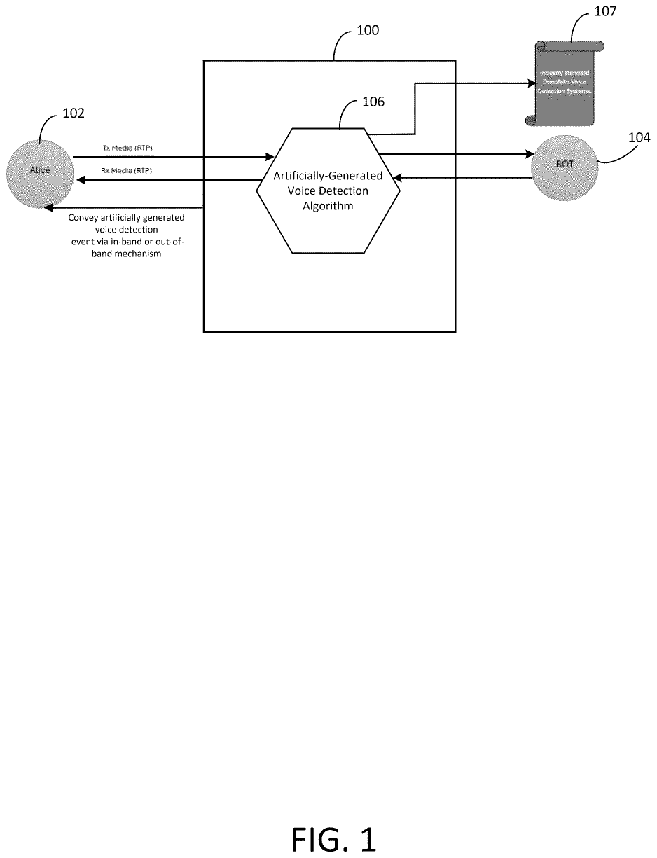

FIG. 1 is a network diagram illustrating a proposed architecture for alerting users of deepfake voice detection. In FIG. 1, a P-CSCF 100 is participating in a media session between a communication endpoint 102 labeled “Alice” and a bot 104 that generates fake or artificially-generated voice content. In FIG. 1, communication endpoint 102 sends RTP packets carrying human generated voice to bot 104 via P-CSCF 100. P-CSCF 100 receives the RTP packets on a single port, performs artificially-generated voice detection using an artificially-generated voice detection algorithm 106, and determines that the voice information carried by the media packets is not artificially generated. Accordingly, P-CSCF 100 forwards the media packets to bot 104 and optionally modifies, transcodes, or inserts packets in the media stream. It should be noted that the artificially-generated voice detection algorithm may be implemented internally to P-CSCF 100, as indicated by artificially generated voice detection algorithm 106 or externally to P-CSCF 100, for example, on an external deepfake voice detection system 107.

When bot 104 transmits media packets carrying artificially-generated voice to communication endpoint 102, P-CSCF 100 receives the packets on a port, performs artificially-generated voice detection using artificially-generated voice detection algorithm 106 and determines that the voice content is artificially generated. Once the artificially-generated voice content is detected, if P-CSCF 100 is using an in-band alerting mechanism, P-CSCF 100 may insert media, such as an announcement or tones, into the existing stream of RTP packets.

If P-CSCF 100 uses an out-of-band alerting mechanism, P-CSCF 100 may send a message or messages separate from the original RTP media stream, where the message or messages carry the alert information in text format. The communication endpoint may receive the alert information in text format and display the alert information in text format to the user, deliver a corresponding alert message in audio format to the user, and/or play an alert tone to the user. In one example, a communication endpoint subscribes with P-CSCF 100 for notification of artificially-generated voice detection and receives the alert via a notify message generated by P-CSCF 100 as part of the subscription. For example, a communication endpoint can transmit a SIP SUBSCRIBE message to P-CSCF 100. The SIP SUBSCRIBE message may identify a new event type, referred to herein as an “artificially-generated-voice-detection” event. When artificially-generated voice detection algorithm 106 detects that the media stream includes artificially-generated voice content, P-CSCF 100 flags the media stream as including artificially generated voice and generates and sends a SIP NOTIFY message to the subscribing endpoint. The SIP NOTIFY message may include information indicating that the media stream may have been artificially-generated, for example, using an AI system, and may optionally include a corresponding confidence score that indicates a probability that the media stream includes artificially-generated voice content. The subscribing endpoint receives the message and may either display or play the alert to the end user, depending on the format in which the alert is transmitted.

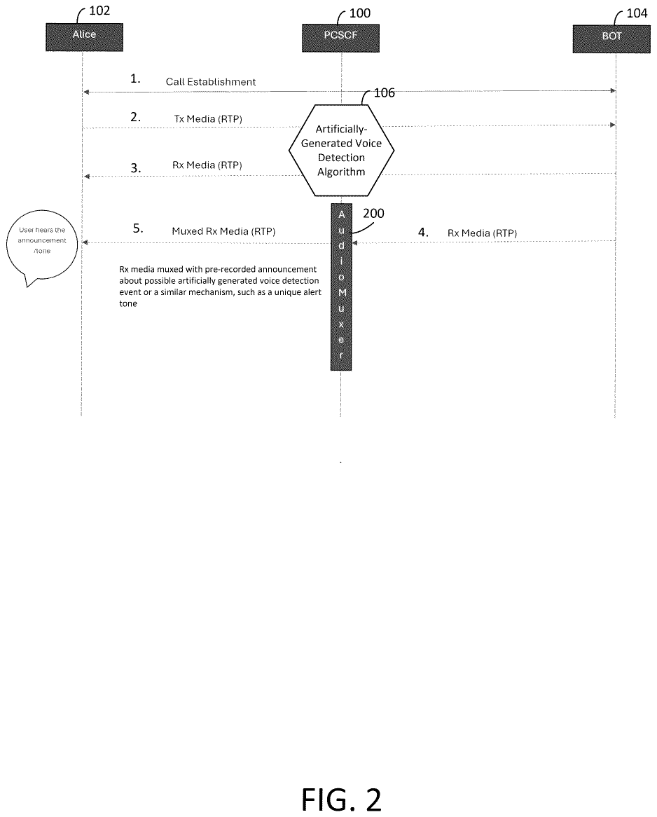

FIG. 2 is a message flow diagram illustrating exemplary messages exchanged for an in-band mechanism for alerting an end user of deepfake voice detection. Referring to FIG. 2, in step 1, communication endpoint 102 and bot 104 exchange SIP signaling messages for call establishment. The SIP signaling messages carry SDP parameters describing the media session. Once the media session parameters have been exchanged, in step 2, communication endpoint 102 sends RTP media packets carrying digitized voice to bot 104 via P-CSCF 100. Artificially-generated voice detection algorithm 106 determines that the media packets do not contain artificially-generated voice content, and P-CSCF 100 forwards the media packets to bot 104. In step 3, bot 104 transmits RTP media packets that include artificially-generated voice content to communication endpoint 102. P-CSCF 100 receives the RTP media packets, and artificially-generated voice detection algorithm 106 determines that the media packets include artificially-generated voice content. In step 4, bot 104 continues to transmit RTP media packets that include artificially-generated voice content to communication endpoint 102. P-CSCF 100 receives the RTP media packets, and an audio multiplexer 200 implemented within P-CSCF 100 multiplexes RTP packets carrying an artificially generated voice detection alert with the original RTP media packets received from bot 104, and P-CSCF 100 forwards the RTP media packets to communication endpoint 102. Communication endpoint 102 receives the media packets and plays the alert tone or message to the end user, alerting the end user that the media from the other communication endpoint includes artificially-generated voice content.

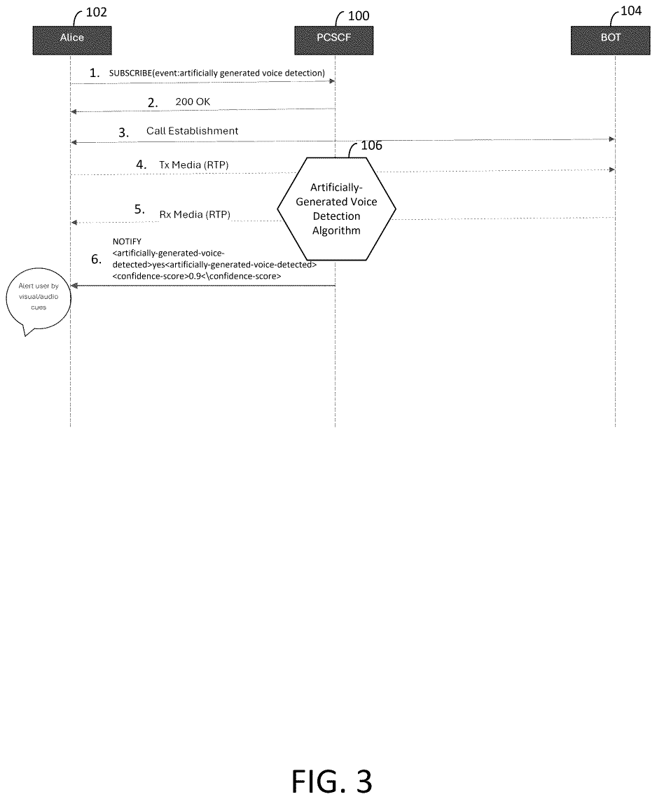

FIG. 3 is a message flow diagram illustrating exemplary messages exchanged for an out-of-band mechanism for alerting an end user of deepfake voice detection. Referring to FIG. 3, in step 1, communication endpoint 102 sends a SUBSCRIBE request message to P-CSCF 100. The SUBSCRIBE request message is a SIP message and may include the following content:
SUBSCRIBE sip:alice@example.com SIP/2.0
Via: SIP/2.0/UDP alice.example.com;branch=z9hG4bK12345
From: <sip:alice@example.com>;tag=alice
To: <sip:alice@example.com>
Call-ID: 1234567890@alice.example.com
CSeq: 1 SUBSCRIBE
Expires: 3600
Contact: <sip:alice@alice.example.com>
Event: artificially-generated-voice-detection
Content-Length: 0

In the example content, the SUBSCRIBE request message includes an Event field with a parameter identifying the event type to which a subscription is requested. In this example, the event type is artificially-generated-voice-detection, indicating that communication endpoint 102 is subscribing to be notified of the detection of artificially-generated voice content in a media stream.

In step 2, P-CSCF 100 responds with a 200 OK message. Example content that may be included in the 200 OK message is as follows:
SIP/2.0 200 OK
Via: SIP/2.0/UDP alice.example.com;branch=z9hG4bK12345;received=alice.example.com
From: <sip:alice@example.com>;tag=alice
To: <sip:alice@example.com>;tag=pcscf
Call-ID: 1234567890@alice.example.com
CSeq: 1 SUBSCRIBE
Contact: <sip:pcscf@pcscf.example.com>
Content-Length: 0
   The 200 OK message confirms successful creation of the subscription.

In step 3, communication endpoint 102 calls bot 104. The calling of bot causes communication endpoint 102 to send a SIP INVITE request message to bot 104. Example content that may be included in the SIP INVITE request message is as follows:
To: <sip:bot@example.com>
Call-ID: 1234567891@alice.example.com
CSeq: 1 INVITE
Contact: <sip:alice@alice.example.com>
Content-Type: application/sdp
Content-Length: [length]
v=0
o=−0 0 IN IP4 alice.example.com
s=Session SDP
c=IN IP4 alice.example.com
t=0 0
m=audio 5000 RTP/AVP 96
a=rtpmap:96 PCMU/8000

P-CSCF 100 forwards the SIP INVITE request message to bot 104, and bot 104 responds with a 200 OK message. Example content that may be included in the 200 OK message is as follows:
SIP/2.0 200 OK
Via: SIP/2.0/UDP alice.example.com;branch=z9hG4bK67890; received=alice.example.com
From: <sip:alice@example.com>;tag=alice
To: <sip:bot@example.com>;tag=bot
Call-ID: 1234567891@alice.example.com
CSeq: 1 INVITE
Contact: <sip:bot@bot.example.com>
Content-Type: application/sdp
Content-Length: [length]
v=0
   o=−0 0 IN IP4 bot.example.com
      s=Session SDP
      c=IN IP4 bot.example.com
      t=0 0
      m=audio 6000 RTP/AVP 96
      a=rtpmap:96 PCMU/8000

In response to receiving the 200 OK message, communication endpoint 102 sends an ACK message to bot 104. Example content that may be included in the ACK message is as follows:
ACK sip:bot@bot.example.com SIP/2.0
Via: SIP/2.0/UDP alice.example.com; branch=z9hG4bK67890
From: <sip:alice@example.com>; tag=alice
To: <sip:bot@example.com>; tag=bot
Call-ID: 1234567891@alice.example.com
CSeq: 1 ACK
Content-Length: 0

After, the call establishment signaling is complete, in step 4, communication endpoint 102 forwards media packets to bot 104 over the established media channel. Bot 104 receives the media packets from communication endpoint 102, and, in step 5, bot 104 transmits media packets containing artificially generated voice content to communication endpoint 102. Artificially-generated voice detection algorithm 106 detects the presence of artificially generated voice content in the media stream. Accordingly, in step 6, P-CSCF 100 generates and sends a SIP NOTIFY message containing an alert indicating the presence of artificially generated voice content to communication endpoint 102. Exemplary content that may be included in the SIP NOTIFY message is as follows:
NOTIFY sip:alice@example.com SIP/2.0
Via: SIP/2.0/UDP pcscf.example.com; branch=z9hG4bK98765
From: <sip:pcscf@pcscf.example.com>; tag=pcscf
To: <sip:alice@example.com>; tag=alice
Call-ID: 1234567890@alice.example.com
CSeq: 1 NOTIFY
Event: artificially-generated-voice-detection
Subscription-State: active
Content-Type: application/xml
Content-Length: [length]
<artificially-generated-voice-detection-event>
<callId>1234567891@alice.example.com</callId>
   <artificially-generated-voice-sender>BOT</artificially-generated-voice-sender> <artificially-generated-voice-receiver>Alice</ artificially-generated-voice-receiver> <artificially-generated-voice-detected>yes</ artificially-generated-voice-detected> <confidence-score>0.9</confidence-score>
</artificially-generated-voice-detection-event>

In the illustrated example, the NOTIFY message identifies the event type as artificially generated voice detection, identifies the sender as a bot and includes a confidence score of .9 indicating a 90% likelihood or probability that the voice content is artificially generated.

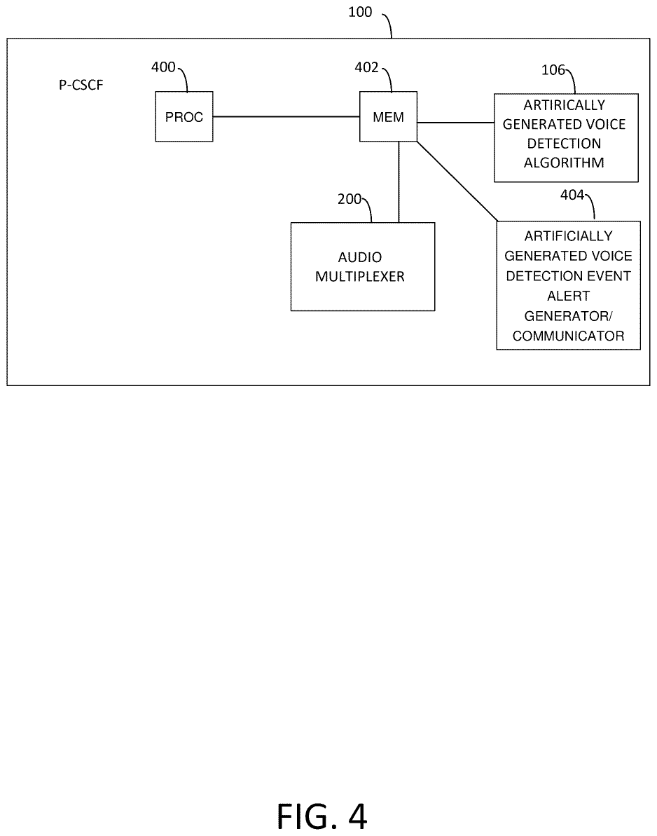

FIG. 4 is a block diagram illustrating an exemplary architecture for P-CSCF 100 including the artificially generated voice detection and alerting functionality described herein. Referring to FIG. 4, P-CSCF 100 includes at least one processor 400 and memory 402. P-CSCF 100 further includes or has access to an artificially generated voice detection algorithm 106, which may detect the presence of artificially generated voice content in a media stream using any of the methods described above. P-CSCF 100 further includes audio multiplexer 200 that is capable of multiplexing alert tones and/or announcements into an existing media stream. P-CSCF 100 further includes an artificially generated voice detection event alert generator/communicator 404 for generating alerts when P-CSCF 100 detects the presence of artificially generated voice content and communicating the alerts to a communications endpoint. In one example, artificially generated voice detection algorithm 106, audio multiplexer 200, and artificially generated voice detection event alert generator/communicator 404 may be implemented using computer executable instructions stored in memory 402 and executed by processor 400.

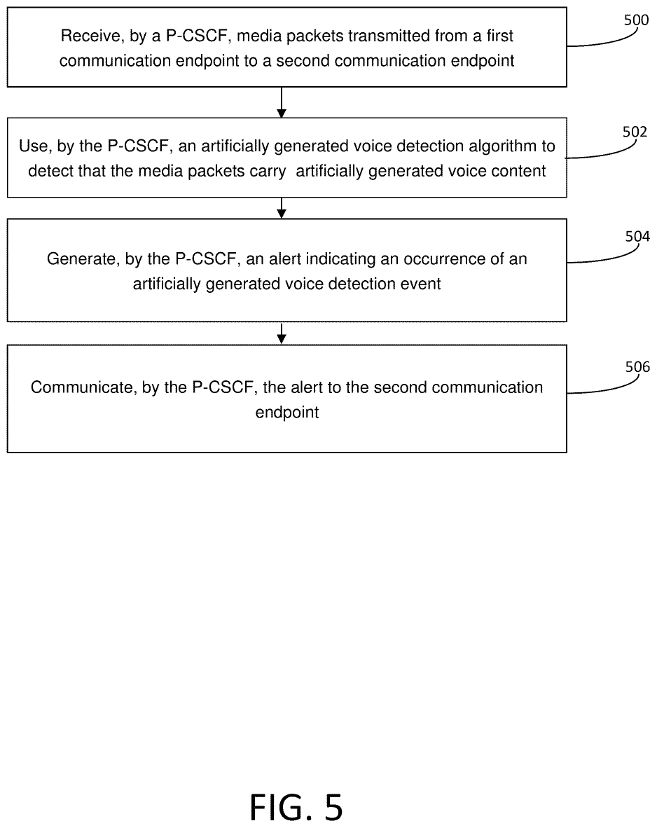

FIG. 5 is a flow chart illustrating a process for providing an alerting mechanism for deepfake voice detection by a P-CSCF. Referring to FIG. 5, in step 500, the process includes receiving, by a P-CSCF, media packets transmitted from a first communication endpoint to a second communication endpoint. For example, P-CSCF 100 may receive media packets transmitted by a communication endpoint operated by a human or a bot impersonating a communication endpoint operated by a human.

In step 502, the process further includes using, by the P-CSCF, an artificially generated voice detection algorithm to detect that the media packets carry artificially generated voice content. For example, P-CSCF 100 may use an internal artificially generated voice detection algorithm or an external artificially generated voice detection algorithm for detecting the presence of artificially generated voice content in a media stream.

In step 504, the process further includes generating, by the P-CSCF, an alert indicating an occurrence of an artificially generated voice detection event. For example, artificially generated voice detection event alert generator/communicator 404 may generate an audio tone, an audio message, and or a text message for alerting and the end user that artificially generated voice content from the remote endpoint has been detected in the communication session. The alert may optionally include a confidence score indicating a likelihood that the voice content from the remote endpoint is artificially generated.

In step 506, the process further includes communicating, by the P-CSCF, the alert to the second communication endpoint. For example, P-CSCF 100 may transmit the alert to the communication endpoint in-band or out-of-band. If P-CSCF 100 communicates the alert in-band, audio multiplexer 200 may multiplex one or more RTP packets containing the alert with RTP packets of an existing media stream from the remote endpoint and transmit the media stream to the communication endpoint. In another example, P-CSCF 100 may communicate the alert to the communication endpoint out-of-band. One example out-of-band communication method is using a SIP NOTIFY message including an indication that an artificially generated voice detection event has occurred.

Exemplary advantages of the subject matter described herein include efficient alerting of end users of the presence of artificially generated voice content in a media stream. The communication is efficient because the communication is achieved using an existing IMS node, such as a P-CSCF, that operates in the signaling path and the media path between communicating endpoints. Such alerting reduces the likelihood of an end user being tricked by artificially generated voice content into providing confidential or other information to malicious third parties.

### References

The disclosure of each of the following references is incorporated herein by reference in its entirety
1. Rosenberg et al., “SIP: Session Initiation Protocol,” IETF RFC 3261 (June 2002)
2. Schulzrinne et al., “RTP: A Transport Protocol For Real-Time Applications,” IETF RFC 3550 (July 2003)
3. Handley et al., “SDP: Session Description Protocol,” IETF RFC 4566 (July 2006)

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for providing an alerting mechanism for deepfake voice detection by a proxy call session control function (P-CSCF), the method comprising:
receiving, by a P-CSCF, media packets transmitted from a first communication endpoint to a second communication endpoint;
using, by the P-CSCF, an artificially generated voice detection algorithm to detect that the media packets carry artificially generated voice content;
generating, by the P-CSCF, an alert indicating an occurrence of an artificially generated voice detection event; and
communicating, by the P-CSCF, the alert to the second communication endpoint.

2. The method of claim 1 wherein receiving the media packets includes receiving real-time transport protocol (RTP) media packets transmitted from the first communication endpoint.

3. The method of claim 2 wherein using the artificially generated voice detection algorithm includes using an artificially generated voice detection algorithm that examines media packet size and timing distributions to detect that the media packets carry artificially generated voice content.

4. The method of claim 1 wherein using the artificially generated voice detection algorithm includes using an algorithm that performs audio codec fingerprinting to detect that the media packets carry artificially generated voice content.

5. The method of claim 1 wherein generating the alert includes generating an audio tone or an announcement indicating the occurrence of the artificially generated voice detection event.

6. The method of claim 1 wherein transmitting the alert to the second communication endpoint includes transmitting the alert in-band to the second communication endpoint.

7. The method of claim 6 wherein transmitting the alert in-band includes multiplexing the alert with the media packets generated by the first communication endpoint.

8. The method of claim 7 wherein multiplexing the alert with the media packets generated by the first communication endpoint includes generating at least one real-time transport protocol (RTP) packet, adding the alert as a payload to the at least one RTP packet, and adding the at least one RTP packet to a stream of the media packets generated by the first communication endpoint.

9. The method of claim 1 wherein communicating the alert to the second endpoint includes communicating the alert out-of-band to the second communication endpoint.

10. The method of claim 9 comprising receiving, by the P-CSCF and from the second communication endpoint, a SUBSCRIBE message for subscribing to an artificially-generated voice detection event and wherein communicating the alert out-of-band to the second communication endpoint includes generating a NOTIFY message, adding the alert to the NOTIFY message, and transmitting the NOTIFY message including the alert to the second communication endpoint.

11. A system for providing an alerting mechanism for deepfake voice detection by a proxy call session control function (P-CSCF), the system comprising:
a P-CSCF including at least one processor and a memory, the P-CSCF for receiving media packets transmitted from a first communication endpoint to a second communication endpoint and using an artificially generated voice detection algorithm to detect that the media packets carry artificially generated voice content; and
an artificially generated voice content detection event alert generator/communicator implemented by the at least one processor for generating an alert indicating an occurrence of an artificially generated voice detection event and communicating the alert to the second communication endpoint.

12. The system of claim 11 wherein the artificially generated voice detection algorithm examines media packet size and timing distributions to detect that the media packets carry artificially generated voice content.

13. The system of claim 11 wherein the artificially generated voice detection algorithm performs audio codec fingerprinting to detect that the media packets carry artificially generated voice content.

14. The system of claim 11 wherein the artificially generated voice content detection alert generator/communicator is configured to generate an audio tone or an announcement indicating the occurrence of the artificially generated voice detection event.

15. The system of claim 11 wherein the artificially generated voice content detection alert generator/communicator is configured to transmit the alert to the second communication endpoint in-band.

16. The system of claim 15 comprising an audio multiplexer configured to multiplex the alert with the media packets generated by the first communication endpoint.

17. The system of claim 16 wherein the audio multiplexer is configured to multiplex the alert with the media packets generated by the first communication endpoint by generating at least one real-time transport protocol (RTP) packet, adding the alert as a payload to the at least one RTP packet, and adding the at least one RTP packet to a stream of the media packets generated by the first communication endpoint.

18. The system of claim 11 wherein the artificially generated voice content detection event alert generator/communicator is configured to communicate the alert out-of-band to the second communication endpoint.

19. The system of claim 18 wherein the artificially generated voice content detection event alert generator/communicator is configured to receive, from the second communication endpoint, a SUBSCRIBE message for subscribing to an artificially-generated voice detection event and to communicate the alert to the second communication endpoint out-of-band by generating a NOTIFY message, adding the alert to the NOTIFY message, and transmitting the NOTIFY message including the alert to the second communication endpoint.

20. A non-transitory computer readable medium having stored thereon executable instructions that when executed by a processor of a computer control the computer to perform steps comprising:
receiving, by a proxy call session control function (P-CSCF), media packets transmitted from a first communication endpoint to a second communication endpoint;
using, by the P-CSCF, an artificially generated voice detection algorithm to detect that the media packets carry artificially generated voice content;
generating, by the P-CSCF, an alert indicating an occurrence of an artificially generated voice detection event; and
communicating, by the P-CSCF, the alert to the second communication endpoint.
